(19) United States
(12) Patent Application Publication
(10) Pub. No.: US 2010/0281065 A1
(43) Pub. Date: Nov. 4, 2010

(54) METHOD FOR ADDING A DATA ITEM TO A COMPOSITION OF DATA ITEMS

(76) Inventor: Helen Balinsky, Cardiff Wales (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/608,743

(22) Filed: Oct. 29, 2009

(30) Foreign Application Priority Data
Oct. 31, 2008 (GB) 0819996.0

(51) Int. Cl. G06F 17/30

(52) U.S. Cl. 707/798; 707/E17.054

(57) ABSTRACT

A method for adding a data item to a composition of data items, the composition of data items including at least two data items which are partially adjacent with respect to one another, the composition defining at least one composite corner, wherein a vertex of a data item is a free vertex if it does not lie substantially on, against or within a boundary of another data item, the composition defining by a first convex polygon determined by joining all contiguous free vertices of the at least two data items using straight line segments, the method including selecting a candidate data item from a set of data items; selecting a candidate position in the composition, a candidate position being substantially on or against a composite corner, or within a boundary of another data item adjacent to a composite corner; placing the selected data item at the candidate position to create a further composition; and accepting the placement of the selected data item if the further composition defines a further convex polygon.

### BACKGROUND

It is known to create a composition of data items by collocating two or more data items. In a known method a person may select a number of data items and place them on a common substrate, such as a piece of card or paper, in some arrangement that is considered by the person to be aesthetically pleasing. As digital cameras have become more widely available, software applications have been developed that can arrange a set of data items, such as digital images, in a composition according one or more rules defined in an arrangement algorithm. The rule or rules of the arrangement algorithm influence the style of a data item composition that is created by the software application.

### SUMMARY OF THE INVENTION

In accordance with a first aspect of the present invention, there is provided a method for adding a data item to a composition of data items, the composition of data items including at least two data items which are partially adjacent with respect to one another, the composition defining at least one composite corner, wherein a vertex of a data item is a free vertex if it does not lie substantially on, against or within a boundary of another data item, the composition defining a first convex polygon determined by joining all contiguous free vertices using straight line segments, the method including: selecting a candidate data item from a set of data items, selecting a candidate position in the composition, a candidate position being substantially on or against a composite corner, or within a boundary of another data item adjacent to a composite corner, placing the selected data item at the candidate position to create a further composition, and accepting the placement of the selected data item if the further composition defines a further convex polygon.

Therefore, the method according to this aspect of the present invention enables a composition of data items to be created whereby the polygon, determined by joining all free contiguous vertices of the composition, is convex, which may be considered by some to be aesthetically pleasing.

According to an embodiment of the present invention, a bounding box of the composition is determined by the smallest upright rectangle that encompasses or encloses the composition and an alignment grid is determined by extending all sides of the data items of the composition until they reach the bounding box, whereby the placement of the selected data item at a candidate position is only accepted if the generated grid is considered to be satisfactory, that is to say that, amongst other possible criteria, it: a) does not contain two parallel lines closer than a predefined minimum limit, and that b) the grid has other internal properties and relations between its cells. For example, there is a degree of proportionality between different cell sizes such that all or some of the dimensions of the cells defined by the alignment grid are proportioned to the extent that the dimension are, for example, multiples of a set of predefined fixed lengths.

An alignment grid which does not contain two parallel lines closer than a predefined minimum limit, and is well proportioned can be considered to be visually attractive. For example, it prevents two data items being partially adjacent by an amount smaller than the predefined minimum limit. This may result in a “good” alignment grid, which will be a term understood by a person skilled in the art. It may also assist in providing internal connectivity between different data items of the composition.

In an embodiment of the present invention, a composition has a perimeter defined by all parts of sides of data items constituting the composition that are not in contact with a another side. The perimeter is therefore the outer boundary of the composition.

A complimentary set is defined by the difference between the perimeter and the outer shell of a composition. The outer shell, or hull, of a composition is the convex polygon defined by joining all contiguous free vertices using straight-line segments.

The placement of a selected data item at the candidate position is only accepted if the further composition has a complementary set that consists only of triangular shapes.

If the complimentary set of a composition contains only triangles then it ensures that the sequence of all angle values inside the perimeter does not contain two sequential 270 degree angles, which may be considered undesirable from an aesthetic viewpoint. For example, with reference to FIG. 7, the outer shell defined by joining the free vertices of the data items of the composition is convex. However, the complimentary set contains a rectangle (area 130), which could be considered by some to give an aesthetically displeasing composition.

The placement of the selected data item at the candidate position is only accepted if:
1) the outer shell of the newly created composition is convex; and
2) the complimentary set of the newly created composition contains only triangles.

In an embodiment of the present invention, the placement of the selected data item at the candidate position is arranged such that the candidate data item has two sides fully or partially adjacent to the sides of the data items in the composition defining the composite corner.

By placing the selected data item at the candidate position a further composite corner is generally created when at least one side of a data item is partially adjacent with a corresponding side of a composite corner nearest the candidate position. The corresponding side is the side of the corner that is substantially parallel with the side in question of the candidate data item when it has one of its vertices placed at the candidate position. It will be appreciated that this means that either of the corresponding sides can be partially adjacent whilst the other side is fully adjacent, or both sides can be partially adjacent with their corresponding sides of the corner. If the candidate data item has at least one side that is partially adjacent with the corresponding side of the candidate corner then placing the data item in the candidate position corresponding to that corner will create a new composite corner. The new composite corner may enable a new candidate position to be selected for a further candidate data item to be placed.

The placement of the selected data item at the candidate position could also be subject one or more predefined aesthetic and/or design rules, which may include checking that a desirable amount of contrast exists between adjacent data items and checking that similar graphic objects within data items are not adjacent or are in a particular orientation with respect to the composition. Alternatively, a composition can consist of all or some data items in which there exists contrast between data items which is below a predefined level such that, rather than having contrast between adjacent items, it is possible that the data items “blend” well, or that the overall composition is balanced in terms of the colour, shade, or content of the data items. For example, the data items may all, or predominantly, be darker in colour (or be of any other similar colour or shade), and therefore will likely blend well together inasmuch as there will be no large discontinuity in contrast between data items in a composition which could otherwise result in an aesthetically displeasing result.

Many aesthetic rules will be apparent to the skilled person, such as distributing similar data items throughout the composition rather than collectively for example, and/or demanding that darker items are lower in the composition than lighter and others. However, it is possible that certain of these rules need not be obeyed in order to arrive at a pleasing, or ‘good’ composition.

In an embodiment of the invention, the placement of the selected data item at the candidate position is only accepted if the lengths of the sides of the data items in the further composition are all substantially multipliers of a predetermined number of fixed lengths.

If the lengths of at least some sides of the data items in the composition are multipliers—to a certain degree of accuracy—of a predetermined number of fixed lengths, the composition may be more aesthetically pleasing than a composition of arbitrary sizes and/or scales. Furthermore, it may improve the connectivity between some data items in the composition.

In an embodiment of the present invention, the method further includes determining whether either there are no more data items in the set of data items or the whether a predetermined number of data items for the composition has been reached and if not, selecting a candidate data item from the data item set, selecting a candidate position associated with an available composite corner(s) and placing the candidate data item in the candidate position to create a further composition. If there are no more data items, or the composition is deemed to be acceptable, the method may include saving the composition in a group of possible compositions and starting a new composition using the method according to claim 1. The method may further include the step of filtering the group of possible compositions by determining whether or not they each adhere to one or more rules and providing a refined group of possible compositions.

This enables a composition that has previously had a further data item placed in a candidate position to have a further data item added to it, until an event occurs such as there being no more data items available in the set or the boundary of the area designated/allocated for the composition being reached, or the composition is deemed acceptable by another rule—for example, the original target was to create a composition of N data items from M content items, where M>N. By this, the method may be followed to create a composition having more than three data items.

In an embodiment of the present invention, the method further includes determining whether the space boundary of a space within which the composition has been structured is less than a predefined distance from a part of the composition and, if so, rescaling at least a part of the composition to a smaller size, thereby increasing the distance between the space boundary and a part of the composition.

If the composition consists, for example, of two large initial data items, it may be that adding the third data item to the composition creates a composition having a side that lies too close to the space boundary. Enabling at least part of the composition to be re-scaled can enable further data items to be added or for the space boundary to be an acceptable or predefined distance from the composition. This can only be applied if one or more data items are scalable.

In an embodiment of the present invention, the steps of placing a vertex of the selected data item at the candidate position to create a further composition and accepting the placement of the selected data item if the further composition defines a further convex polygon includes firstly placing a vertex of the data item at a candidate position such that two sides of the selected data item are at least partially adjacent to two sides of the existing composition, secondly, determining whether the further polygon determined by joining all contiguous free vertices of the composition using straight line segments is convex, and thirdly, determining whether the complimentary set of the further composition consists of triangles only, and, if so, accepting the data item placed at the candidate position.

In an embodiment of the present invention, the steps of placing the selected data item at the candidate position to create a further composition; and accepting the placement of the selected data item if the further composition defines a convex polygon includes: firstly, determining the size and shape of a candidate data item; secondly, determining if the further polygon determined by joining all contiguous free vertices of the further composition using straight line segments is convex, should the data item be placed at the candidate position and, if so, placing the data item at the candidate position to create the predetermined further composition. Thus the system used predetermined information on the size, geometry etc of the data item to determine, in the event that the data item were to be placed at a candidate position, whether the further polygon determined by joining all contiguous free vertices of using straight line segments would be convex. If it is determined that the further polygon of the further composition would be convex, and that its complimentary set consists of triangles then the selected candidate data item is placed at the selected candidate position.

In an embodiment of the present invention, the data items may be rectangular in shape.

Alternatively, the data items may be irregular. In this case, a rectangular bounding box can be formed around the data item. The data item can then be processed according to the present invention using its bounding box. The bounding box can be the smallest upright rectangle that encloses the design embodied by the data item. The bounding box may include some non-zero boundary or offset to the actual contents. In the case that the data item is a block of text or a document for example, it could be desirable (but not necessary) to have data items coinciding with their rectangular bounding box at least for internal items of the composition or have some offset. In some styles, for example, the composition can be a single blob composition (design) made from two or more tightly packed data items and contain no internal holes/unfilled gaps inside it. In certain instances, it may be appropriate for an irregularly shaped data item to be used at the periphery of a composition if its use fulfils certain of the aesthetic criteria for the composition. For example, if the use of an irregularly shaped data item results in a convex composition, it can be used providing that no other data items need to added around the irregularly shaped one resulting in a non-convex composition.

In an embodiment of the present invention, the data items may comprise images, blocks of texts, graphical objects, or their combinations, or, the data items may comprise video or animated data segments (for example, if the composition is part of a web page or similar). In such cases, the rules regarding the placement of data items based, wholly or in part, on the nature of their relative contrast, colour or shade etc may not be appropriate for use.

In accordance with a second aspect of the present invention, there is provided a computer program arranged to carry out the method according to claim 1.

In accordance with a third aspect of the present invention, there is provided a data carrier having a computer program according to claim 17 stored thereon.

In accordance with a fourth aspect there is provided a computing apparatus arranged to process data representing data items in accordance with the method as claimed in claim 1.

### BRIEF DESCRIPTION OF THE DRAWINGS

Embodiments of the present invention will now be described, by way of example only, with reference to the accompanying drawings, in which:

FIG. 1(a) is a schematic representation of two partially adjacent data items of a composition according to an embodiment of the invention;

FIG. 1(b) is a schematic representation of the perimeter of the composition of FIG. 1(a);

FIG. 1(c) is a schematic representation of the convex polygon defined by the composition of FIG. 1(a) and defining the outer shell for the composition;

FIG. 1(d) is a schematic representation of the alignment grid, including the bounding box, of the composition of FIG. 1(a);

FIG. 2 is a schematic representation of the composition of FIG. 1(a) showing straight-line segments spanning a composite corner;

FIG. 3 is a schematic representation of the composition of FIG. 2 including a further data item placed in a composite corner using a method according to an embodiment of the present invention, such that the convex polygon, or outer shell, of the composition remains convex;

FIG. 4 is a schematic representation of the composition of FIG. 2 including a further data item placed in a composite corner using a method not forming part of the invention, such that the convex polygon of the composition no longer remains convex;

FIG. 5 is a schematic representation of a composition of five data items having a complimentary set that includes individual shapes which are only triangular;

FIG. 6 shows a further data item placed in a composite corner of the composition of FIG. 5, by a method according to an embodiment of the present invention, such that the complimentary set only includes individual shapes that are triangular;

FIG. 7 shows a further data item placed in a composite corner of the composition of FIG. 5, by a method not forming part of the invention, such that the complimentary set includes an individual shape that is non-triangular;

FIG. 8 is a flow chart illustrating a method for creating a composition according to an embodiment of the present invention; and

FIG. 9 is a flow chart showing illustrating a method for creating an initial composition for use in the method according to an embodiment of the present invention.

### DETAILED DESCRIPTION

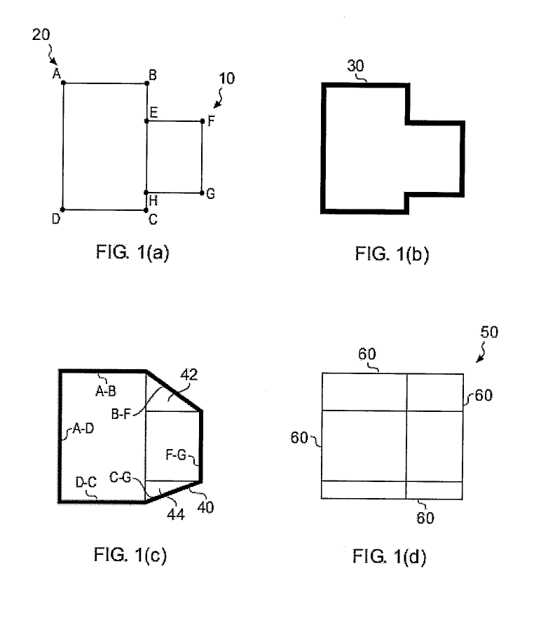

FIG. 1(a) shows a composition of data items including a first data item 10 and a second data item 20, positioned in a partially-adjacent manner. In this embodiment, a data item 10, 20 refers to a rectangular substrate that forms a part of a composition. However, a data item 10, 20 according to the present invention may comprise any suitable content item and/or be any suitable shape. In some embodiments a data item 10, 20 is a graphic object such as a photograph or logo, a text object such as a block of text or writing, or a generally transparent data item with a visual object, such as a flower, positioned at a location on the data item. In other embodiments a data item 10, 20 may comprise a combination of an image and text or a text only document. It should be noted that all examples provided in this specification are non-exclusive. The sides of a data item may enclose the content of the data item 10, 20 and in some embodiments there may be a space between the content and the sides of a data item 10, 20. Where a data item 10, 20 comprises a plurality of discrete content parts, such as graphics and text, the sides may enclose all of the content of the data item 10, 20. The sides of a data item 10, 20 form a boundary for the data item 10, 20. A data item may or may not be scalable.

In the illustrated composition each data item is rectangular. However, in other embodiments, a data item may be of any shape, but with a rectangular bounding box, which can comprise an offset between the edge of the bounding box and the content of the item. The first data item 10 has vertices E, F, G and H. The second data item 20 has vertices A, B, C and D. The first data item 10 and second data item 20 are partially adjacent via side E-H and B-C, respectively. In this embodiment the term “partially adjacent” means that two data items 10, 20 are adjacent with a partially shared side. However, in other embodiments the term partially adjacent may mean that the two data items overlap one another, the partially adjacent sides being substantially parallel to one another, such that an area of overlap is formed. In some examples the area of overlap will be a regular polygon, such as a rectangle.

Two partially adjacent data items will each have a contacting or overlapping part of a side. In some embodiments the contacting or overlapping part may be the entire side. One of the data items, in the case of FIG. 1(a) the first data item 10, may have a contacting side that is shared completely with the data item that it is partially adjacent with. However, when this is the case, the contacting side of the other data item, in the case of FIG. 1(a) the second data item 20, will generally be longer than the corresponding contacting side of the other data item 10. At least one contacting side of two partially adjacent data items will therefore have a “free part” and, in some cases, each contacting side may have a free part.

A vertex is a “free vertex” if it does not lie on, against a side of another data item, or if it does not lie within a boundary of another data item. For example, vertices A, B, C, D, F and G are free vertices, whereas vertices E and F are not as they lie on side B-C of data item 20.

A side is a “free side” if it does not contact or overlap another side that is parallel with respect thereto. For example, E-H is not a free side and E-F is a free side. B-C is not a free side but has free parts B-E and H-C. Free parts of non-free sides can define parts of a perimeter of a composition.

FIG. 1(b) shows the “perimeter” 30 of the composition shown in FIG. 1(a). The perimeter 30 is defined by the outermost sides of the composition, and free parts of sides, that enclose the composition. More specifically, the perimeter 30 is composed of each free side in the composition and any free parts of the remaining sides that are external to the composition i.e. all parts of sides of data items constituting the composition that are not in contact with a another side parallel with respect to the part of the side. The perimeter 30 is the outer boundary of the composition. It should be noted that the perimeter 30 is shown as a thicker line than the sides for emphasis only.

FIG. 1(c) shows the outer shell of the composition, which according to the present invention should be a convex polygon 40. The outer shell 40 of a composition is determined by joining all contiguous free vertices using straight line segments so as to create an enclosed shape. In order to provide an aesthetically pleasing composition, the outer shell should be a convex polygon. However, it will be appreciated that adjacent free vertices can be joined in any sequence to create the convex polygon. As can be see from FIG. 1(c), the convex polygon is created by joining free vertices D and A with a straight line segment which overlays or coincides with free side A-D, joining free vertices A and B with a straight line segment which coincides with free side A-B, joining free vertices B and F with a straight line segment which does not coincide with any side of an data item, and so on until an enclosed shape is formed. It should be noted that in FIG. 1(c) the outer shell 40 of the composition is convex and is shown as a thicker line for emphasis only.

FIG. 1(d) shows the “alignment grid” 50 of the composition shown in FIG. 1(a). The alignment grid is determined by first determining the “bounding box” 60 of the composition, the bounding box 60 being the smallest upright rectangle that encompasses or encloses the composition, and then extending each side within the composition such that each side contacts opposing sides of the bounding box 60. The bounding box 60, in this embodiment, has sides of equal width to the width of the sides of the composition and is aligned with corresponding free sides of the composition.

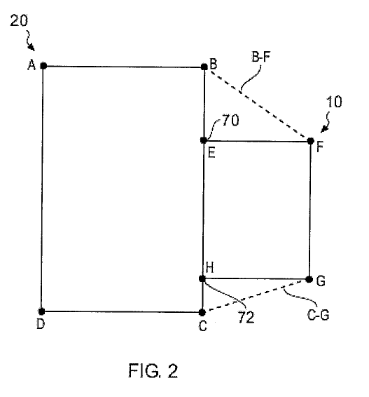

Referring to FIG. 2, the composition of FIG. 1(a) is shown indicating generated straight line segments B-F and C-G interposed between free vertices B and F and free vertices C and G. A “composite corner” ∠BEF (70) faces outwardly from the composition and is formed by two partially adjacent data items 10 and 20. The composition of this embodiment has a first composite corner 70 and a second composite corner 72. A composite corner may have a further data item placed in it so as to add a further data item to the composition. The composite corner 70 is composed of free part B-E and free side E-F. The composite corner 72 is composed of free part H-C and free side H-G.

According to an embodiment of the present invention a further data item may be placed in a candidate position corresponding to or associated with a composite corner of a composition including at least two partially adjacent data items. A candidate position corresponds to a composite corner when it is on or against the candidate corner or adjacent the candidate corner and within the boundary of a data item contributing to the composite corner.

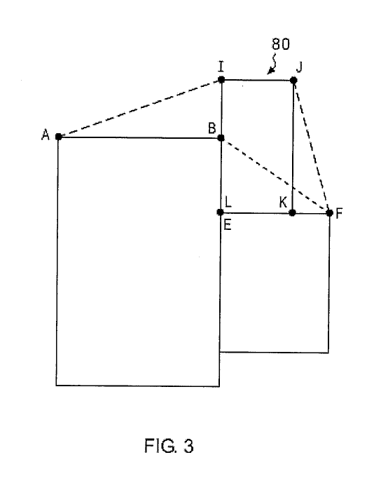

As shown in FIG. 3, a candidate data item 80 is placed in a candidate position, which in this embodiment is aligned with the composite corner ∠BEF, such that the outer shell of the newly created composition is convex. For the illustrated embodiment the terms candidate position and composite corner are interchangeable. The term “convex” means that there are no internal angles of the outer shell that are greater than 180 degrees. By placing a further data item in a composite corner of composition, it produces a composition of tightly packed data items. Put another way, by placing a further data item in a composite corner of the composition it produces a composition having no internal holes or unfilled gaps inside its perimeter. It will be noted that, for the new outer shell to be convex, the further data item, once placed in the composite corner, must contact or intersect the straight line segment B-F corresponding to, or spanning, the composite corner. As can be seen from FIG. 3, the further data item intersects the straight line segment B-F. In the case that the new content item does not intersect B-F, the outer shell will not be convex. One side, I-L, of the candidate data item 80 is longer than the corresponding side, B-E, of the composite corner and thus the local part of the new outer shell is determined by joining free vertices I and A using straight line segment A-I and joining free vertices J and F using straight line segment J-F. It will be noted that vertex B, that was a free vertex prior to the placement of further data item 80, is no longer a free vertex as it now lies on the side I-L of further data item 80.

The method according to this embodiment involves selecting a candidate data item from a data item set, selecting a candidate position associated with an available composite corner and placing the candidate data item at the candidate position.

A candidate data item is placed in a composite corner such that two sides of the content item are fully or partially adjacent to the sides of the composite corner. If there are any partially adjacent sides, at least one new composite corner is created.

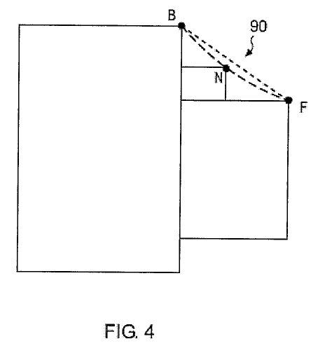

Referring now to FIG. 4 an example of a composition formed not in accordance with the invention is illustrated in which a further data item 90 is placed in a composite corner. The further data item is of a size that is small enough such that it does not contact or intersect the straight line segment 74 corresponding to that composite corner and, consequently, the convexity of the outer convex polygon is destroyed.

As can be seen from FIG. 4, the internal angle ∠BNF of the outer shell is greater then 180 degrees which means that this part of the outer shell is concave. According to the present invention, it is not acceptable to have any concave parts to the outer shell as this could result in a composition which is not aesthetically pleasing.

If the free apex N of the further data item 90 contacts the straight line segment B-F, then the internal angle between first and second straight line segments B-N and N-F will be 180 degrees and thus in this embodiment the outer shell is convex.

If the free apex N of the further data item 90 lies beyond the straight line segment B-F, and the aspect ratio of the data item 90 is such that the data item still lies within or on the bounding box of the initial composition, then placing any subsequent data items of a similar or larger size could result in a composition having a concave portion, or the complimentary set between the perimeter and outer shell containing a rectangle. We call such a placement, wherein adding a data item does not change the bounding box of the composition a terminal node, meaning that no further data items can be placed in any composite corner which is created by the placement of the further data item. Strictly speaking a very small data items could be still placed into the terminal nodes, however, such placement are very likely to create a very close alignment lines in the composition grid. In some embodiments a terminal node may be created using a data item containing a graphic object, for example as a flower, as this can be deemed to be visually attractive.

The candidate data item is placed such that at least one side that is partially adjacent with the corresponding side of the candidate corner, then at least one or possibly two new composite corners are created.

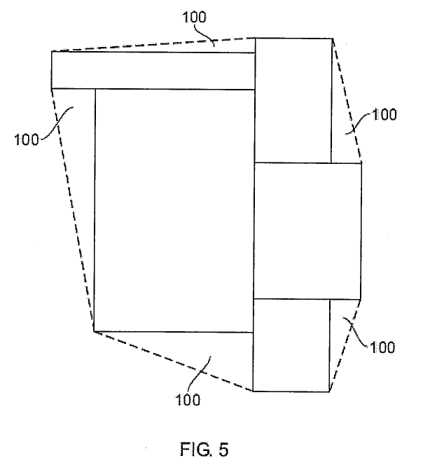

FIG. 5 shows a composition of five data items. The complimentary set between the outer shell and the perimeter of the composition consists of five, triangular, shapes 100. There are five composite corners supporting five respective candidate positions at which an apex of a further data item may be placed.

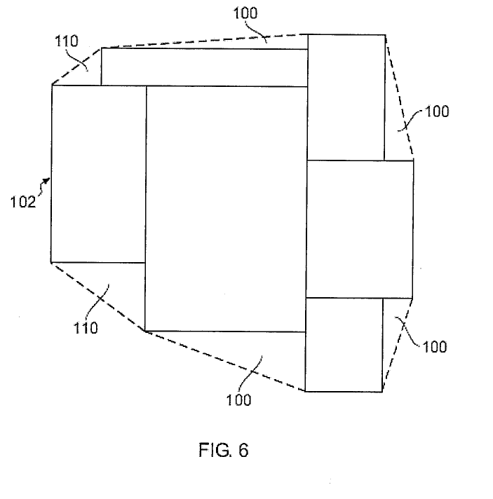

As shown in FIG. 6, a further data item 102 has been placed using a method according to an embodiment of the invention such that the complimentary set contains individual shapes which are only triangular. Placing the further data item 102 in the composite corner indicated in FIG. 6 has added two new shapes 110 to the complimentary set, both of which are triangular. The shape of the outer shell of the composition is convex.

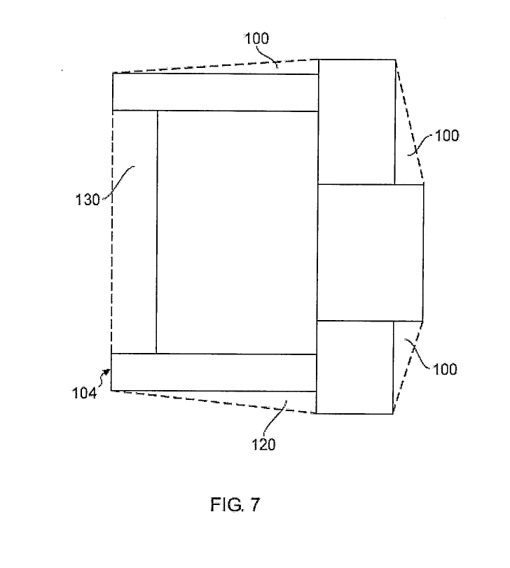

Referring to FIG. 7, an example of a further data item 104 being placed in the composition of FIG. 5 in a manner not in accordance with the present invention is shown. As can be seen, the complimentary set has lost one shape 100 and gained two new shapes 120 and 130. Shape 130 is non-triangular and thus, due to this, the placement of this further data item 104 in the indicated composite corner is contrary to the invention.

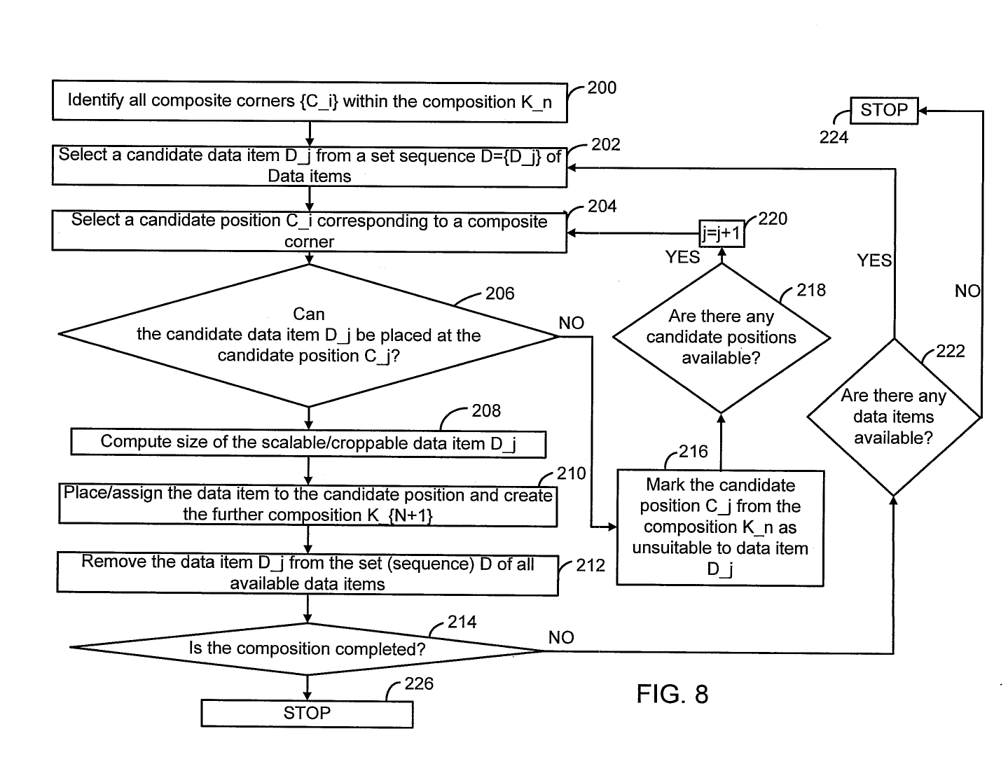

FIG. 8 shows a flow chart illustrating a method according to an embodiment of the invention for adding a data item to a composition of data items. At step 200 the method involves identifying all of the composite corners Ci within a composition Kn of data items.

At step 202, a candidate data item Dj is selected from the set or sequence of data items D ={Dj}. The set of data items may contain a plurality of data items that are to be added to the composition. The data item can be selected at random, in sequence or according to a set of rules. For example, an item can be selected based on its relative importance within the set, or according to other criteria, such as aesthetic criteria (e.g. the colour, shade, saliency, or content of the item).

At step 204 the method involves selecting a candidate position Ci corresponding to a composite corner. The candidate position can be selected at random, or according to a set of rules, for example, the position can be selected based on a desired direction for expanding a composition or based on the proximity of the composite corner to objects which may impede the expansion of the composition, such as the edge of a document for example. Thus, a candidate position that is associated with a composite corner is selected.

At step 206 the method involves the step of determining if the candidate data item Dj can be placed at the candidate position Ci. The item can be placed at the candidate position if the further composition Kₙ₊₁ that is created by placing the selected candidate data item Dj at the candidate position results in a composition with an outer shell which is convex, and in which the complementary set defined by the difference between the outer shell of the composition and its perimeter consists of triangularly shapes areas. At this stage, other rules can be implemented such as aesthetic rules for example, in order to provide an extra layer of validation in making a composition. For example, it is possible to reject a candidate item because it has a predominant colour which would clash with that of the existing composition at the candidate position.

If the data item Dj can be placed into the candidate position Ci, then at step 208 the size of the data item is defined. If item Dj is croppable and/or scalable further transformations can be applied to improve the underlying design grid of the composition Kₙ₊₁. For example, the proportions of the composition can be altered by scaling and/or cropping the item Dj in order to comply with a set of predetermined rules relating to the aesthetic characteristics of the composition whilst ensuring that the outer shell of the composition Kn+1 remains convex, and the complementary set consists only of triangles.

At step 210 the data item Dj is assigned to, or placed at, the candidate position Ci in order to create the further composition Kₙ₊₁.

At step 212, the item Dj is removed from the set D so that it cannot be used again.

If the composition can be considered complete according to a set of aesthetic or other criteria (step 214), then the method ends (226). Alternatively, it is determined if there are any further data items available for placement (step 222). If there are not, the method ends (224). If there are, the method proceeds to step 202.

If the item Dj cannot be placed in the position Ci (206), then the position Ci is marked at step 216 as unsuitable for this data item for the composition Kn. The method proceeds to step 218 in order to determine if there are any further candidate positions available. If not, the method proceeds to step 222. If there are, the next position from the set of available candidate positions is selected, and the method proceeds to step 204.

In the above description, the method was implemented by iterating over the set of candidate items D. It will be appreciated that the method can be implemented by iterating over the set of candidate positions C instead. The method proceeds in essentially the same way, but the set of candidate positions must be updated every time a data item is placed into the composition.

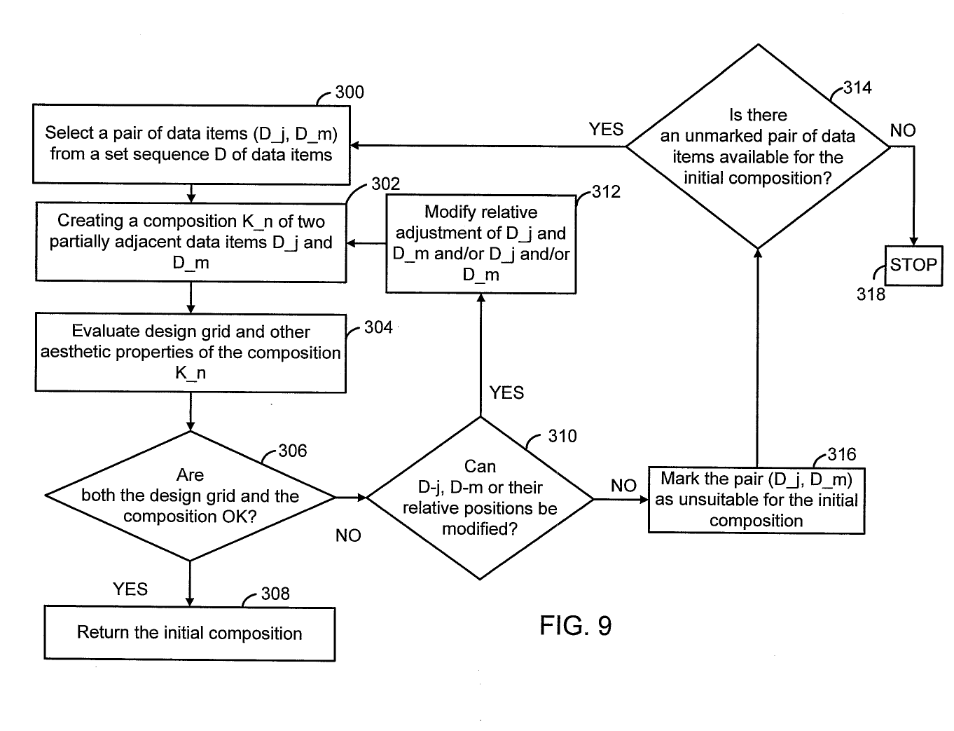

FIG. 9 shows a flow chart illustrating a method of creating an initial composition of two data items according to an embodiment of the invention.

At step 300 a pair of data items Dj, Dm are selected from a set or sequence D of data items. A composition Kn is created at 302 by placing the items Dj, Dm in a partially adjacent manner as shown, for example, in FIG. 1a.

At step 304 a design grid and other properties of the composition Kn is computed for the composition Kn. FIG. 1d shows an example of a design grid obtained according to an embodiment.

At step 306, if it is determined that the grid and overall composition are acceptable then the composition Kn is returned (step 308), and is ready to be used as input to the method as described with reference to FIG. 8 (i.e. input at step 200 of FIG. 8).

If the composition is not acceptable, it is determined if there are any adjustments that can be made to the relative position of the items Dj, Dm at step 310 in order to give an acceptable composition. For example, the images can have their relative positions changed, and/or one or both of the images can be made larger or smaller and/or cropped (if appropriate).

If no adjustments can be made the pair of items Dj, Dm are marked as unsuitable for the initial composition Kn (step 316). At step 314 there is check to determine if there are any unmarked data item pairs available for the initial composition. If not, the method ends at step 318. If there are unmarked (i.e. potentially suitable) pairs of data items, the method returns to step 300 in order that another pair may be evaluated.

If there are modifications that can be made to the composition Kn consisting of the pair Dj, Dm, the method proceeds to step 312 where a modification is selected and performed. Following this, the method returns to step 302.

Many aesthetic rules for placing data items in a composition will be apparent to a person skilled in the art, for example, determining which data items should or should not be placed next to one another and/or which data items are more important to the composition.

The skilled person will be familiar of ways that a free composite corner can be identified, such as determining pixel values when the method is implemented by a computer program. A list of pixel coordinates of candidate positions may be maintained and further as data items are added to the composition and new composite corners are created.

In an embodiment, the steps of placing the selected data item at a candidate position therefore comprise:
1) matching a vertex of the content item with the vertex of the composite corner; and
2) ensuring that two sides of the data item are partially or fully adjacent to the sides of the composite corner, with at least one side partially adjacent.

To create a further composition and accept the placement of the selected data item it must be ensured that:
1) the outer shell of the further composition, determined by joining all contiguous free vertices of the composition is a convex polygon; and
2) that the complimentary set between the outer shell and perimeter of the composition contains only triangularly shaped areas; and
3) that any other relevant designer, aesthetic or stylist rules are implemented and obeyed (the rules may vary for different styles).

In another embodiment, the steps of placing the selected data item at the candidate position to create a further composition and accepting the placement of the selected data item if the further composition defines a further convex polygon includes, firstly, determining the size and shape of a candidate data item. If the original size does not fit, and the selected data item can be scaled, it can be scaled (within reason) in order to attempt to get a fit. If the item can be cropped then it may also be cropped (within reason) to get a fit, or if both operations are allowed, they can both be preformed as appropriate.

Secondly, determining if the outer shell of the composition, determined by joining all contiguous free vertices using straight line segments, is convex, and determining if the complimentary set contains only triangularly shaped areas.

If these criteria are met the candidate item can be placed at the candidate position. Thus the system uses predetermined information on the size, geometry etc of the data item to determine, in the event that a selected vertex of the data item were to be placed at a candidate position, whether the outer shell of the newly created composition, determined by joining all contiguous free vertices of the composition using straight line segments, would be convex and whether the complimentary set consists from triangles only. If it is determined that the further outer shell of the further composition would be convex and the complimentary set would consist form triangles only, then the candidate data item is placed at the selected candidate position.

The candidate data item may in some embodiments be placed such that two sides are partially or fully adjacent (with at least one side is partially adjacent) with sides of the composite corner within which the data item is placed.

Generally, when a further data item is placed in a candidate position, if the data item stays within the bounding box for the composition then the corner which the data item has been placed in becomes a “terminal node”, meaning that no further data items, apart from extremely small ones, can be placed in a candidate position corresponding to a corner contributed to by the data item as to do so would break another rule, such as the complimentary set containing only triangles. If a further data item intersects the bounding box when placed in a composite corner then it will generally result in a further composite corner or two composite corners. This property can be used, for example, to expand the composition in some directions but not in others and to create more prominence to some data items in the group. Where the skilled person would see it as appropriate, one or more of the features of this embodiment can be combined with the features of the other described embodiments. For example, either of the methods according to embodiments of the present invention placing a further data item in a composite corner of a composition could include, say, the feature of checking the alignment grid, or checking aesthetic rules are obeyed.

In some embodiments, the method can be used to produce and save a large number of potential compositions, say 1000, that are each composed from the same data item set and each obey the convexity rule, i.e. that the convex polygon remains convex. A user may then select a first aesthetic attribute, or further law or rule, that it is desired for a composition to adhere to. This could be, for example, that the composition does not contain any two dark data items that are adjacent. Another example is that a certain data item is located in a certain part or area of the composition. The method according to such embodiments would include a step of filtering the large number of potential compositions to determine which of those adhere to the stipulated rules. This may return, say 500 potential compositions. The method may then involve a user stipulating further rules, with which the compositions must comply, so as to filter the number of returned compositions down to, say, a more manageable 10 potential compositions that all adhere to, inter-alia, one or more user stipulated rules in addition to the convexity rule. If the method is being implemented on a computer, the user may save or print one or more of the 10 compositions.

Where the number, or type, of data items in a set causes a series of compositions to be generated, i.e. the data item set is distributed across a number of compositions, then the potential compositions described in the preceding paragraph may be potential series' of compositions.

In other embodiments, one or more of the rules that a composition is to adhere to are defined before the potential compositions are generated and the user is thus presented with only those potential compositions that obey the pre-defined rules.

The method according to embodiments of the invention can be implemented by a suitably programmed computer.

1. A method for adding a data item to a composition of data items, the composition of data items including at least two data items which are partially adjacent with respect to one another, the composition defining at least one composite corner, wherein a vertex of a data item is a free vertex if it does not lie substantially on, against or within a boundary of another data item, the composition defining a first convex polygon determined by joining all contiguous free vertices using straight line segments, the method including:
selecting a candidate data item from a set of data items;
selecting a candidate position in the composition, a candidate position being substantially on or against a composite corner, or within a boundary of another data item adjacent to a composite corner;
placing the selected data item at the candidate position to create a further composition; and
accepting the placement of the selected data item if the further composition defines a further convex polygon.

2. The method as claimed in claim 1, wherein placing the selected data item further comprises:
providing that two sides of the data item are respectively partially and/or fully adjacent to two corresponding sides of the candidate position.

3. The method as claimed in claim 1, wherein the complementary set of areas defined by the difference between the further convex polygon and the perimeter of the further composition comprises triangularly shaped regions.

4. The method according to claim 1, whereby a bounding box of the composition is determined by finding the smallest rectangle that encompasses or encloses the composition and an alignment grid is determined by extending all sides of the data items of the composition until they reach the bounding box, whereby the placement of the selected data item at the candidate position is only accepted if the further composition does not contain two parallel lines closer than a predefined minimum limit.

5. The method according to claim 1, whereby the placement of the selected data item at the candidate position is only accepted if the further composition obeys one or more predefined aesthetic rules.

6. The method according to claim 5, wherein an aesthetic rule includes checking that a desirable amount of contrast exists between adjacent data items and checking that similar graphic objects within data items are not adjacent or are in a particular orientation with respect to the composition.

7. The method according to claim 1, whereby the placement of the selected data item at the candidate position is only accepted if the lengths of the sides of the data items in the further composition are all substantially multipliers of a predetermined number of fixed lengths.

8. The method according to claim 1, further including determining whether either there are no more data items in the set of data items or the whether a predetermined number of data items for the composition has been reached and if not, selecting a candidate data item from the data item set, selecting a candidate position associated with an available composite corner(s) and placing the candidate data item in the candidate position to create a further composition and accepting the placement of the selected data item if the further composition defines a further convex polygon.

9. The method according to claim 8, whereby if there are no more data items, or the composition is deemed to be acceptable, the method includes saving the composition in a group of possible compositions and starting a new composition.

10. The method according to claim 9, the method further including the step of filtering the group of possible compositions by determining whether or not they each adhere to one or more rules and providing a refined group of possible compositions.

11. The method according to claim 1, the method further including determining whether the boundary of a space within which the composition has been structured is less than a predefined distance from a part of the composition and, if so, rescaling at least a part of the composition to a smaller size, thereby increasing the distance between the space boundary and a part of the composition.

12. The method according to claim 1, whereby the steps of placing a selected data item at the candidate position to create a further composition; and accepting the placement of the selected data item if the further composition defines a further convex polygon includes: firstly, placing a vertex of the selected data item at a candidate position and, secondly, determining whether the further polygon determined by joining all contiguous free vertices of the at least three data items using straight line segments is convex and, if so, leaving the selected data item placed at the candidate position.

13. The method according to claim 1, whereby the steps of placing a vertex of the selected data item at the candidate position to create a further composition; and accepting the placement of the selected data item if the further composition defines a further convex polygon includes: firstly, determining the size and shape of a selected candidate data item; secondly, determining if the further polygon determined by joining all contiguous free vertices of the at least three data items using straight line segments would be convex, should a vertex of the data item be placed at the candidate position; and if so, placing a vertex of the data item at the candidate position to create the predetermined further polygon.

14. The method according to claim 1, wherein the data items are regular polygonal in shape.

15. The method according to claim 14, wherein the data items are rectangular in shape.

16. The method according to claim 1, wherein the data items comprise images.

17. A computer program arranged to carry out the method according to claim 1.

18. A data carrier having a computer program according to claim 17 stored thereon.

19. A computing apparatus arranged to process data representing a set of data items for a composition of data items, the apparatus comprising a processor operable to perform the method as claimed in claim 1.
